(19) United States
(12) Patent Application Publication
(10) Pub. No.: US 2015/0211381 A1
(43) Pub. Date: Jul. 30, 2015

(54) SUBMERSIBLE TURBINE SYSTEM

(71) Applicants: Felix Antonio Torrent, Las Heras (AR); Jose Ricardo Torrent, Las Heras (AR)

(72) Inventors: Felix Antonio Torrent, Las Heras (AR); Jose Ricardo Torrent, Las Heras (AR)

(21) Appl. No.: 14/596,441

(22) Filed: Jan. 14, 2015

Related U.S. Application Data
(60) Provisional application No. 61/931,151, filed on Jan. 24, 2014.

(51) Int. Cl. F01D 23/00; H02K 7/18

(52) U.S. Cl. CPC F01D 23/00; H02K 7/1823; Y10S 415/916; F03B 17/04

(57) ABSTRACT

The present development is a system (10) substantially submerged in a liquid such as water. It includes a plurality of bags (50) connected to a rotating belt (40) each injected with air (A) such that as each bag rises, it pulls the belt upwards. The turning belt drives a wheel or sprocket (20) connected to a drive (22) shaft which is, in turn, connected (21) to a generator (25) for generating energy in a well-known manner. After the inflated bags (50) have risen towards the surface (WL) and as they are being redirected downwardly by the return side of the belt (47), they (50) are deflated. They (50) are then moved by the belt (40) to a position (46) wherein they get inflated (70,72,74) again and rise.

### CROSS-REFERENCE TO RELATED APPLICATIONS

This application claims priority to U.S. Provisional Patent Application No. 61/931,151 filed on Jan. 24, 2014 which is incorporated herein in its entirety by reference and made a part hereof.

### FEDERALLY SPONSORED RESEARCH OR DEVELOPMENT

N/A

### TECHNICAL FIELD

The present invention generally relates to turbines for generating power, and in particular, to a submersible turbine primarily used underwater.

### BACKGROUND OF THE INVENTION

Wind turbines and tide and wave turbines are well-known and have proven to be quite successful. Nevertheless, in a further quest to both harness and use the forces of nature to generate energy, the use of water, air, and buoyancy has not been used to their full potential.

### SUMMARY OF THE INVENTION

The present development is a system that captures air and uses the principles of buoyancy to generate energy by harnessing and directing the forces of the captured air as it travels through a more dense fluid, such as water.

The system uses a chain or belt entrained around two wheels. The belt is driven by inflated bags or bladders of air attached to the belt. One of the wheels is connected to a generator for generating energy by the turning wheel. This energy is used to power an air compressor for inflating the bags and to feed the power grid/electrical system connected thereto.

It is believed that this system is both clean and green as no waste is produced by it. It can run itself after start-up and generates electricity constantly, with or without sunlight, winds, and tides. It is a self-contained system as the energy it uses is generated by it with the excess energy being generated by it being used to supply energy to other systems. It is further believed that the system is inexpensive, economical and reliable.

### BRIEF DESCRIPTION OF THE DRAWINGS

To understand the present invention, it will now be described by way of example, with reference to the accompanying drawings in which:

FIG. 1 is a schematic drawing of the system of the present invention; and,

FIG. 2 is a detail of one of the bags used in the system of the present invention.

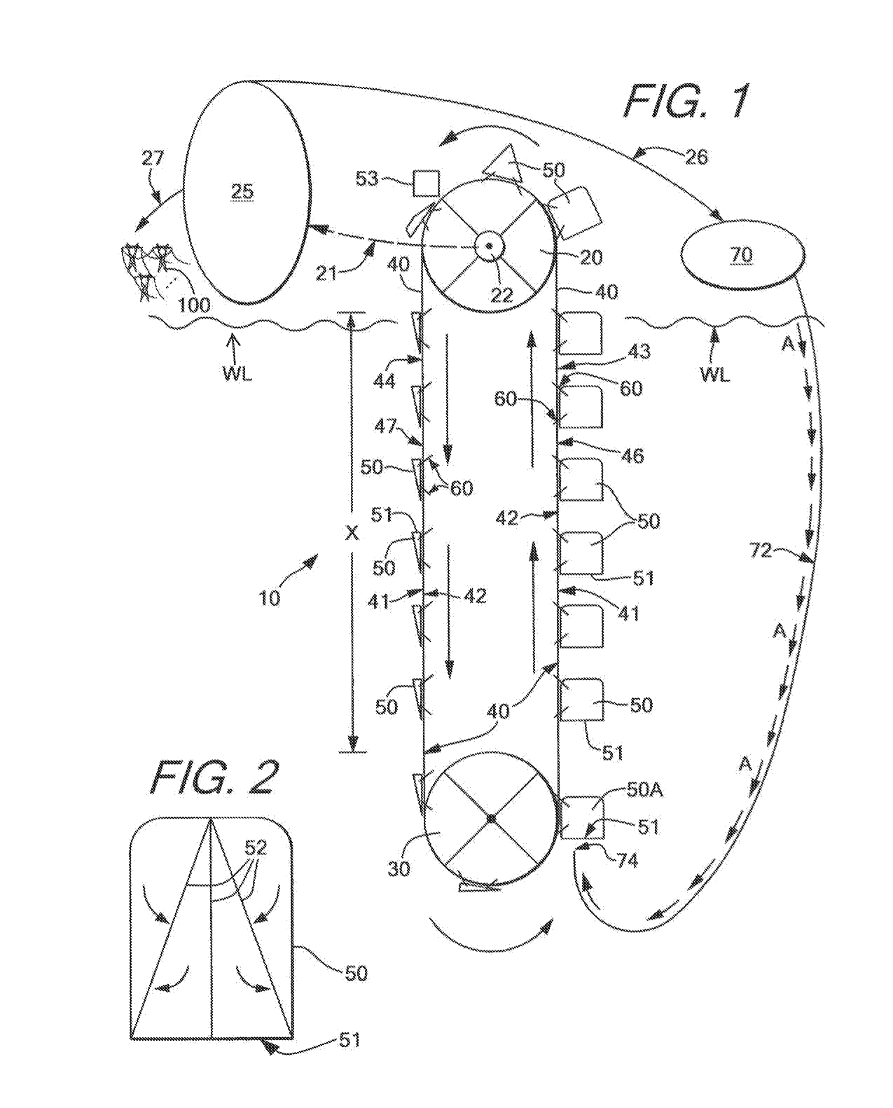

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

Very generally, under Archimedes' Principle, an object immersed in a fluid is buoyed up by a force equal to the weight of the fluid displaced by the object. This upward force opposes the weight of the immersed or submerged object. In a body of water having a depth, such as an ocean, sea, or lake, the pressure increases as the depth increases. Specifically, due to gravity and the weight of the water, there is more pressure at the lower depths than the higher depths. This difference in pressure thus results in a net force tending to accelerate the buoyant object upwards. Accordingly, an object having a density greater than the fluid will thus sink and an object having a density less than the fluid will thus rise and float.

The present development relies on this Principle as the objects of the invention are bags that are filled with air at the lower depths and allowed to rise. However, no attempt is made herein to claim protection in such Principle or other law of nature or other abstract principle. What will be disclosed and claimed herein are mechanisms, apparatuses, systems that utilize this Principle to generate electricity. Additionally, the present development involves a method or process for converting forces generated by natural buoyancy into electricity, and, therefore there is a transformation of energy from one form to another.

The bags are connected to a rotating belt so that as the bags rise, they pull the belt upwards. The turning belt drives a wheel or sprocket connected to a drive shaft which is, in turn, connected to a generator for generating energy in a well-known manner. After the inflated bags have risen towards the surface and as they are being redirected downwardly by the return side of the belt, they are deflated. They are then moved by the belt to a position wherein they get inflated again and rise. Using two wheels and an entrained belt, this process can continue indefinitely.

Referring now to the Figures, the turbine 10 of the present system incorporates a primary wheel or sprocket 20 and secondary sprocket 30 spaced a distance X from one another and a portion is submerged in a fluid such as water having a waterline designated WL. The primary sprocket is preferably positioned at a depth less than that of the secondary sprocket, and in a preferred form of the invention, the first wheel has a portion below the WL and in another preferred form the first wheel is entirely above the WL. In a preferred form of the invention the second wheel has a portion positioned below the WL and in a more preferred form, the entire second wheel is positioned below the WL.

An endless belt or chain 40 having an outer surface 41 and inner surface 42 is entrained around the two wheels 20,30. The inner surface 42 contacts and frictionally or mechanically, such as by sprockets, drive the wheels 20,30. For illustrative purposes the system described has the wheels rotating counterclockwise. The wheels can, of course, rotate clockwise. With the wheels 20,30 rotating counterclockwise, the belt has a working portion 46 generally between the lower wheel 30 and the upper wheel which moves upwardly and acts upon and drives the upper wheel 20. The belt will also have a return portion 47 generally between the upper wheel 20 and the lower wheel 30.

A plurality of air capturing bags 50 are spaced-apart and connect to the outer surface 41 of substantially the entire belt 40. Each bag 50 is connected to the belt 40 by one or more connectors 60. Preferably, the bags are substantially equally spaced apart.

The primary wheel 20 has a drive shaft (point 22) that is mechanically linked (shown schematically at 21) to a generator 25, such as through a power intake shaft, to generate electricity by well-known techniques, such as a rotor/stator assembly. The generator 25 may be mechanically linked to the secondary sprocket 30 or other portion of the system without departing from the scope of the present invention. The energy generated by the generator 25 can be transmitted through well known means to a location requiring the electrical energy for any purpose. In one preferred form of the invention, the electrical energy generated is transmitted to one or both of the air compressor 70 and the electric power grid 100. More specifically, electricity is fed via an electrical transmission line 26 to the air compressor 70 and via a separate electrical transmission line 27 to an electrical power grid 100. An air-line or hose 72 from the air compressor 70 feeds air A into the individual bags 50 so as to inflate the bags 50 as they pass by the outlet 74. Specifically, proximity switches (not shown) can be placed so as to detect a bag about to pass by the hose outlet 74. Once detected, air can be released into a passing open bag 50.

In particular, each bag 50 has an opening 51 therein for permitting air to flow both into and out of the bag. The air A from the compressor 70 travels through the hose 72 to the opening 74 at a distal end thereof so as to feed the bag 50 closest to the secondary wheel 30 (identified as bag 50A). The buoyancy of the air filled bag 50 exerts an upward force on the portion 46 of the belt 40 attached to the inflated bag 50A to move in a direction from the secondary wheel 30 towards the primary wheel 20 resulting in the primary wheel rotating counterclockwise. As subsequent bags 50 pass by or adjacent the air outlet 74, each will inflate and thus continue and drive the rotation of the wheels.

As the inflated bag 50 passes around the primary sprocket 20, it is deflated or emptied of air using an internal or an external skeleton or through an inherent structure of the bag. Alternatively, an optional station 53 compresses or operatively engages the inflated bag, and more preferably, into a flattened or nearly flattened condition. After the bag is substantially deflated or evacuated of air, it continues to travel towards the secondary sprocket 30 on the return portion 47 of the belt 40. As shown in FIG. 2, each bag 50 can include an internal structure or skeleton 52 so as to promote or ensure its collapsing as it turns or travels towards the secondary sprocket 30. In this manner it reduces any drag (upward forces) it may cause on the return portion 47 of the belt traveling from the primary wheel 20 to the secondary wheel 30. It is contemplated that an external structure could also be used in place of the internal structure or that the bag will have a specific geometry and material properties to provide the same function without an internal or external skeleton.

The process is continuous as bags are constantly being inflated to drive a front portion 43 of the belt 40 upwardly to the primary wheel 20 connected to the generator 25, such as through a power input shaft of the generator, much like a wind turbine.

While a portion of the system 10 is shown to be above the waterline WL as discussed above, it is recognized that the entire system, apart from the air compressor 70, can be submerged by weights and anchors so as to avoid it presenting an obstacle to watercrafts and it from facing weather dangers. If desired, portions of the system 10 can be further encapsulated in waterproof shelters.

As to further specifics:

The wheels/sprockets 20,30 are rigid and are anchored. The distance X between the wheels can be varied and dependent on numerous factors, such as space available, currents, safety, limitations on support structures, the type of fluid (sea water or fresh water), etc. Also, the diameter of the wheels can vary based on similar factors. Additionally, the primary and secondary wheels can have the same or differing diameters, and most preferably the same diameter.

The compressor 70 preferably collects the surrounding, environmental air and compresses it. It is believed that separate air supply tanks are not necessary but could be employed if desired.

The bags 50 are semi-rigid so as to permit both their inflation and deflation and durability. It is desirous that they have some rigidity so as to maintain a constant shape during their ascent and to drive the chain/belt. The internal structure or frame 52 of bags 50 can open up and close the bags. Similar type frames can be found in umbrellas which can be mechanically opened and closed. Here the bags must open when air is introduced into them and must close on their return trips on the backside of the belt. A mechanical switch or electrical signal can be associated with the frame to cause its opening and/or closing at particular locations or positions relative to the wheels and air outlet. The bag 50 can also be evacuated by the station 53.

The bag connectors 60 are preferably rigid links allowing only minor pivoting of the bags relative to the belt.

The operation of generating electricity described herein can be controlled by a computer having a processor running software and connected to proximity sensors, pressure sensors, air flow sensors, switches, feedback circuits and the like to ensure proper timing of filling and emptying of the bags, the desired internal pressure of the filled bags and the emptied bags, the period of belt rotation, the rate of the generator input shaft rotation as well as other control parameters well known to those skilled in the art.

The belt/chain 40 must be durable and may be metal or a rigid, yet flexible, rubber, polymeric, composite or synthetic material. The belt may also be treated or coated to prevent or reduce oxidation, organic growth, and sea life attachment to name a few. The belt also may be treated or coated with a material to decrease the friction with the water.

The choice of materials for the many components will be dependent upon the environment, such as salt content, temperature, turbulence, durability, and safety. Finally, it should be mentioned that while one system is shown, many can be set-up adjacent one another. A grid of similar turbines can be vertically erected and horizontally spaced apart from one another, much like wind-farms today.

While the specific embodiments have been illustrated and described, numerous modifications come to mind without significantly departing from the spirit of the invention, and the scope of protection is only limited by the scope of the accompanying Claims.

What is claimed is:

1. An energy turbine at least partially submerged in a fluid denser than air comprising:
a first wheel and a second wheel spaced apart with one of the wheels being connected to a power input shaft of a generator;
a belt entraining the two wheels;
a plurality of spaced apart bags connected along the belt;
a supply of air individually inflating each bag as it travels from the second wheel to the first wheel thereby driving the power input shaft of the generator to generate electricity; and
a mechanism for deflating each bag as it travels from the first wheel to the second wheel.

2. The turbine of claim 1 wherein the mechanism for deflating is an internal skeleton in the bag, an external skeleton on the bag, or a station separate from the bag.

3. The turbine of claim 1 further comprising an air compressor for inflating each bag and wherein the electricity generated by the generator energizes the air compressor.

4. The turbine of claim 1 wherein the fluid is water having a waterline and a portion of the first wheel is positioned above the waterline.

5. The turbine of claim 4 wherein the first wheel is entirely above the waterline.

6. The turbine of claim 4 wherein a portion of the second wheel is below the waterline.

7. The turbine of claim 6 wherein the second wheel is entirely below the waterline.

8. The turbine of claim 1 wherein the first wheel is a sprocket.

9. The turbine of claim 1 wherein the first wheel is connected to the power input shaft.

10. The turbine of claim 2 wherein the station operatively engages one of the plurality of bags to drive air out of the bag.

11. The turbine of claim 1 wherein each bag of the plurality of bags is pivotally connected to the belt.

12. The turbine of claim 1 wherein the first wheel and the second wheel have substantially equal diameters.
